(19) United States
(12) Patent Application Publication
(10) Pub. No.: US 2024/0412660 A1
(43) Pub. Date: Dec. 12, 2024

(54) Handwriting Scoring Tool

(71) Applicant: Jennifer Caupain, Atlanta, GA (US)

(72) Inventor: Jennifer Caupain, Atlanta, GA (US)

(21) Appl. No.: 18/329,715

(22) Filed: Jun. 6, 2023

(51) Int. Cl. G09B 11/04

(52) U.S. Cl. CPC G09B 11/04

(57) ABSTRACT

A handwriting scoring tool and method of use may include a transparency sheet, a plurality of guide boxes of varying sizes, each of the plurality of guide boxes including a dashed midline, a box baseline, and a baseline aligner. In some embodiments, the transparency sheet may include a handwriting reference guide, which includes a plurality of reference characters, each reference character including guide dots which indicate the start position of a writing instrument, and a plurality of guide arrows and numbers which indicate the stroke direction and the stroke order. The method of using the handwriting scoring tool may include aligning the transparency sheet with the baseline of the paper, aligning the transparency sheet with the letter to be scored, comparing the size of the letter with the size of the box and the position of the dashed midline, comparing the bottom of the letter with the baseline aligner, using a guide box to check the space between letters, and using a guide box to check the space between words.

### FIELD OF THE INVENTION

The present invention relates generally to teaching aids. More specifically, the present invention is a handwriting scoring tool.

### BACKGROUND OF THE INVENTION

Teachers, therapists, and other similar professionals often need to devote a great deal of time to scoring the handwriting of their students. Scoring handwriting can be a very subjective process that relies on the professional's subjective view of the handwriting, including judging spacing, size of the text, and alignment of the text with the baseline on the paper. This process can introduce inconsistencies and errors in grading and critiquing due to inconsistencies in the subjective application of the visual calculus used by the professional during the grading process. There thus exists a need for a convenient, portable tool that assists in removing the subjectivity from the grading process and provides a foolproof, efficient means of grading, scoring, and critiquing handwriting.

The present invention is a handwriting scoring tool that aims to solve this problem. The handwriting scoring tool comprises a transparency sheet. The transparency sheet may further comprise a transparent base, waterproof material, and permanent ink forming at least one printed box on the transparency sheet. The at least one printed box may further comprise a dashed midline, a baseline aligner, and a box baseline. In an ideal embodiment, the at least one printed box may comprise five total printed boxes of varying sizes, each intended to serve a different age, grade, or developmental level of the student. For example, a larger box may be used to be more forgiving for a kindergarten student, while a fifth grade student may be scored using a smaller box to encourage more precise writing. To grade a paper, a user may overlay the transparency sheet on top of the paper to be graded. The user may then align one of the printed boxes with a letter to be graded. The user then aligns the baseline of the paper with the baseline of one baseline of one of the box baselines. The user then observes the letter's size and placement in relation to the printed box. For example, if the user is grading a capital letter, the user may check if the letter's height exceeds the dashed midline of the printed box. The user may then check if the base of the letter is within the zone of acceptable deviation from the baseline using the baseline aligner. Further, the printed box can be used to check both the space between letters and the space between words. In some embodiments, the user may check if there is less than one box width of space between letters, and within one to two box widths of space between words.

In some embodiments, the handwriting scoring tool may further comprise a handwriting guide printed onto the transparency sheet. The handwriting guide comprises a plurality of reference letters, a plurality of arrow guides, a plurality of guide dots, and a plurality of number guides. The plurality of reference letters may be used as a guide by the user for judging the shape of characters being graded. The plurality of reference letters has a plurality of guide dots, indicating where the student should place the writing implement down when writing each letter. Some letters may have multiple guide dots for letters that require multiple separate strokes from the writing implement. Each reference letter may further be surrounded by a plurality of arrow guides that indicate which direction the writing implement should be moved. Each of the arrow of the plurality of arrow guides may further include a number that indicates the stroke order for each letter. With this tool, the user may further be able to use the transparency sheet as a reference tool during the teaching process, allowing easy access to reference from proper shape and stroke order when observing students.

Thus, the present invention provides a portable, efficient handwriting scoring tool that is capable of serving a variety of age groups and developmental levels of students.

### BRIEF DESCRIPTION OF THE DRAWINGS

FIG. 1 is a perspective view of the present invention.

FIG. 2 is a front view of the present invention.

FIG. 3 is a front view of an embodiment of the present invention having five total printed boxes.

FIG. 4 is a flowchart showing the method of grading letter size using the present invention.

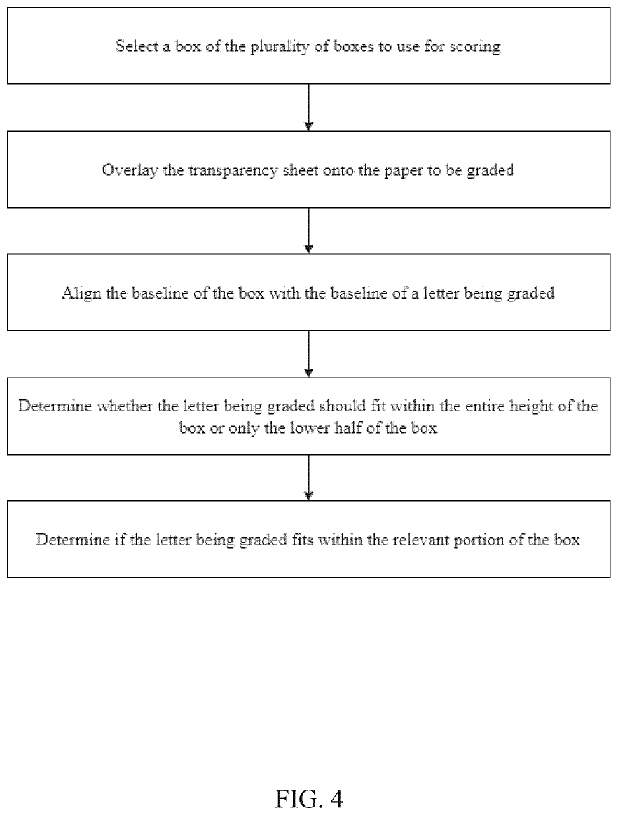

FIG. 5 is a flowchart showing the method of scoring letter placement using the present invention.

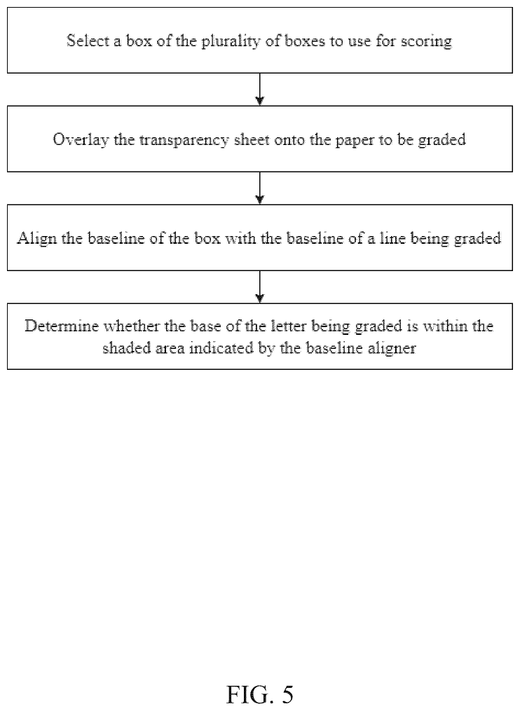

FIG. 6 is a flowchart showing the method of scoring word spacing using the present invention.

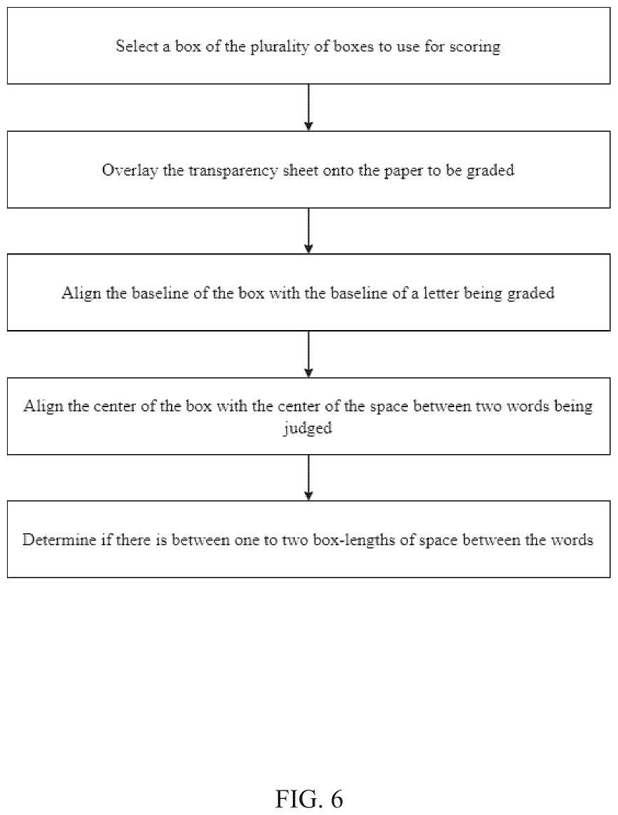

FIG. 7 is a flowchart showing the method of scoring letter spacing using the present invention.

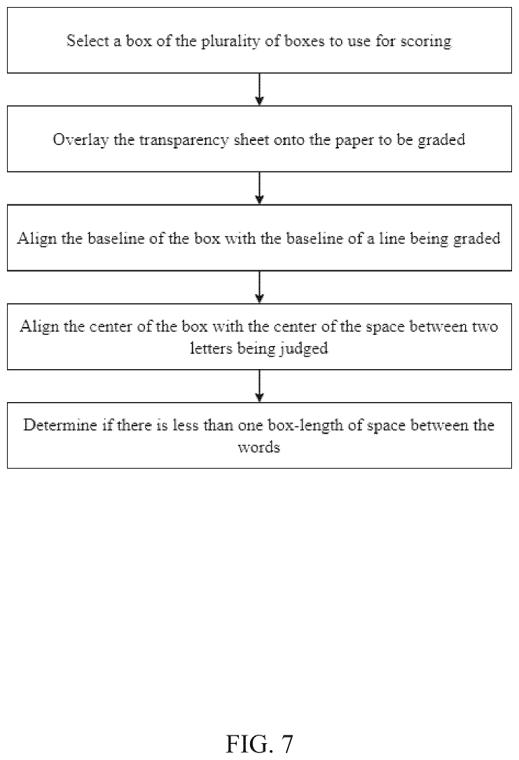

FIG. 8 is a flowchart showing the method of judging letter and number formation using an embodiment of the present invention.

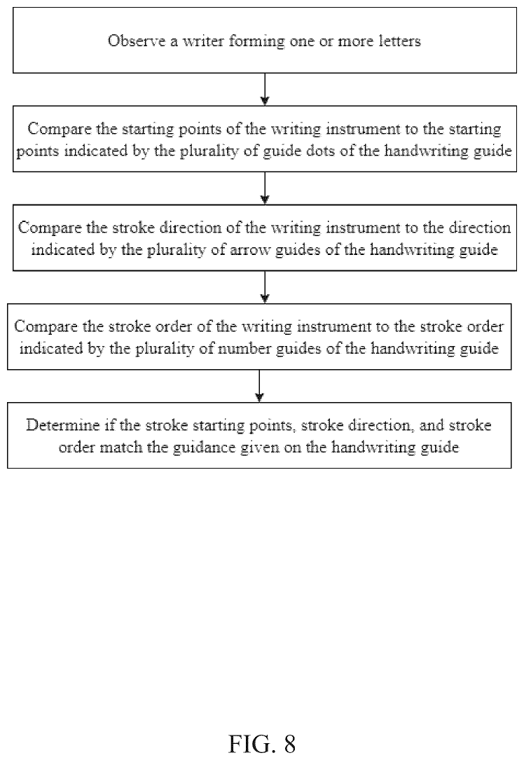

### DETAIL DESCRIPTIONS OF THE INVENTION

All illustrations of the drawings are for the purpose of describing selected versions of the present invention and are not intended to limit the scope of the present invention.

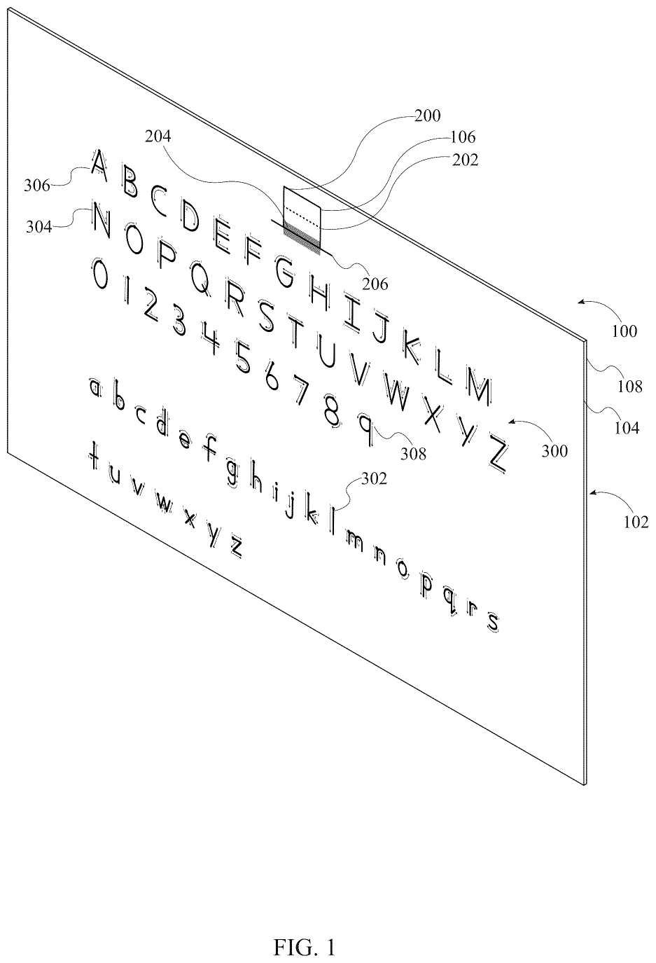

Referring now to FIGS. 1-3, the handwriting scoring tool 100 comprises a transparency sheet 102, at least one printed box 200, and in some embodiments, may further comprise a handwriting guide 300.

The transparency sheet 102 is made from a clear or frosted transparent base 108, such that the transparent base 108 is not completely opaque. In the ideal embodiment, the material is a clear plastic, though other materials are within the spirit and scope of the present invention. The transparency sheet 102 may further comprise a waterproof material 104 and permanent ink 106.

In the ideal embodiment, the transparency sheet 102 further comprises the waterproof material 104. The waterproof material 104 may be layered on one or both sides of the transparent base 108.

In the ideal embodiment, the transparency sheet 102 further comprises permanent ink 106 printed into the transparency sheet 102. The permanent ink 106 forms the figures necessary for the handwriting scoring tool 100 to measure handwriting. In the ideal embodiment, the permanent ink 106 forms at least one printed box 200. Other configurations, shapes, or figures formed by the permanent ink 106 to assist with scoring handwriting are within the spirit and scope of the present invention.

The at least one printed box 200 further comprises a dashed midline 202, a baseline aligner 204, and a box baseline 206. As seen in FIGS. 1-3, the dashed midline 202 is placed horizontally roughly halfway between the bottom and top of the at least one printed box 200. The dashed midline 202 is adapted to allow the user to clearly view whether the height of a measured letter falls within acceptable parameters. For example, capital letters should have their tops above the dashed midline 202, while most lowercase letters should not rise past the dashed midline 202. The box baseline 206 comprises a horizontal line that makes up the bottom of the at least one printed box 200. The box baseline 206 is a straight line that runs along the bottom of the at least one printed box 200, intended to allow the user to properly line up the transparency sheet 102 with the baseline on the paper being scored. The at least one printed box 200 further comprises a baseline aligner 204. The baseline aligner 204 comprises a partially opaque shaded shape near the box baseline 206 of the at least one printed box 200, as seen in FIGS. 1-3. The baseline aligner 204 allows the user to see whether the handwriting being graded is within an acceptable deviation of the baseline of the paper. If the base of the letter falls within the shaded region of the baseline aligner 204, the handwriting can be considered within the acceptable deviation. If the base of the letter falls either too high or too low outside of the baseline aligner 204, the handwriting may be considered misaligned with the baseline on the paper and can be graded accordingly.

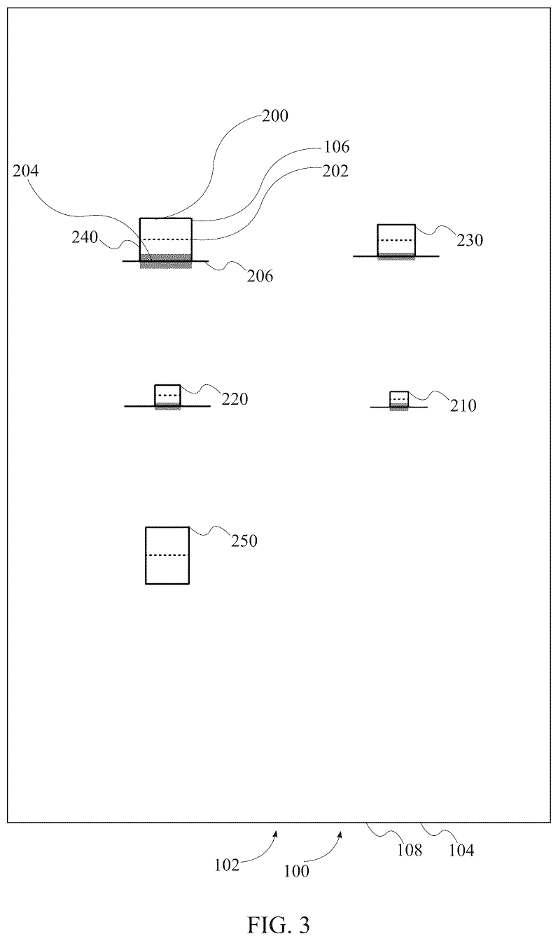

In an ideal embodiment, shown in FIG. 3, the at least one printed box 200 comprises five total boxes: a first box 210, a second box 220, a third box 230, a fourth box 240, and a fifth box 250. Each box is intended to give acceptable parameters for varying levels of handwriting skill. For example, a smaller box may be intended to grade higher levels, such as fifth grade students or higher, and a larger box that is adapted to give more deviation may be suitable for grading younger students, such as kindergarten students or pre-kindergarten students. Thus, in the ideal embodiment, the boxes vary in size from small to large: the first box 210 is smaller than the second box 220, the second box 220 is smaller than the third box 230, the third box 230 is smaller than the fourth box 240, and the fourth box 240 is smaller than the fifth box 250. In this embodiment, the fifth box 250 would be adapted to serve for grading the youngest students, and the first box 210 would serve for grading older, more experienced students who are expected to have better handwriting. An exemplary division of these boxes may be as follows: the first box 210 is intended for fourth grade students and up, the second box 220 is intended for second to third grade students, the third box 230 is intended for first grade students, the fourth box 240 is intended for kindergarten students, and the fifth box 250 is intended for pre-kindergarten students.

In this embodiment having five total boxes, at least one of the boxes may lack a baseline aligner 204—in this embodiment, the fifth box 250 does not comprise a baseline aligner 204. This would be the case for younger students who are not expected to have a firm grasp on baseline placement. In such a case, no baseline aligner 204 is needed, and the baseline of the handwriting is compared directly to the box baseline 206 of the at least one box or may be compared directly to the baseline on the paper being graded.

Further, in this embodiment having five total boxes, at least one of the boxes may have a larger baseline aligner 204 to accommodate students with a lower level of writing skill. This allows more leeway to be given to these students. In the ideal embodiment, as seen in FIG. 3, the fourth box 240 may have a larger baseline aligner 204, and would be intended to grade students at the pre-kindergarten or kindergarten level.

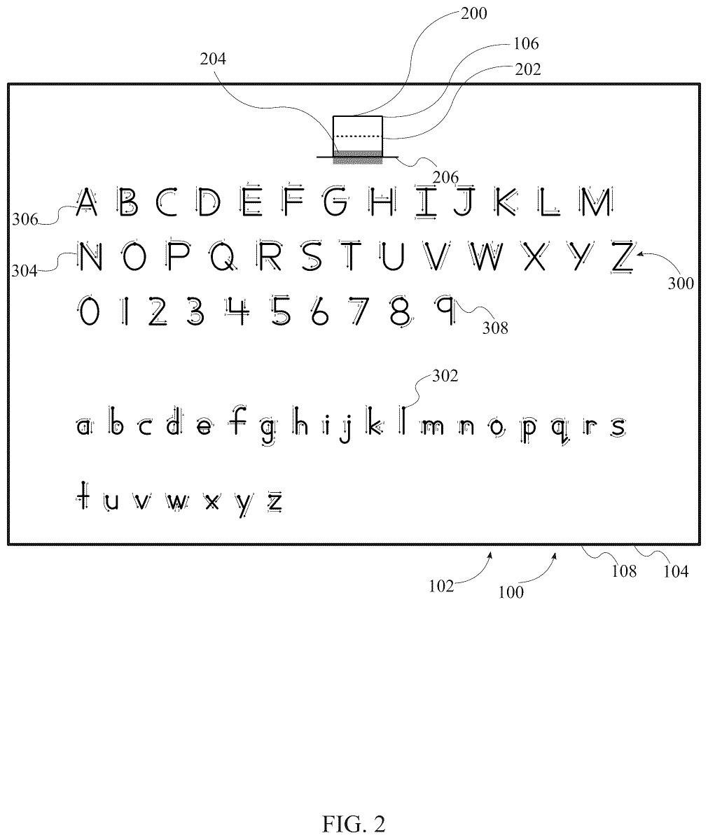

Referring now to FIGS. 1 and 2, in one embodiment, the handwriting scoring tool 100 may further comprise a handwriting guide 300. The handwriting guide 300 may comprise a plurality of guide dots 302, a plurality of arrow guides 304, a plurality of reference letters 306, and a plurality of number guides 308.

The handwriting guide 300 comprises a plurality of references letters. The plurality of reference letters 306 may comprise letters, numbers, or other characters as needed. For each letter in the plurality of reference letters 306, a plurality of guide dots 302 are present on each letter. The plurality of guide dots 302 are small but visually perceivable black dots that indicate the starting position for strokes of the writing instrument for the reference letter. Next to each of the plurality of guide dots 302, an arrow guide of the plurality of arrow guides 304 may be present. Each arrow of the plurality of arrow guides 304 is used to indicate the stroke direction—for example, if the stroke is meant to go from top to bottom of the paper, the arrow may be pointing towards the bottom of the paper. There may be a number guide of the plurality of number guides 308 in proximity to each arrow of the plurality of arrow guides 304. The number guides 308 are used to indicate the stroke order. For example, if the downward stroke is the first stroke, that will have the number “one” by the relevant arrow guide. The second stroke will have the number “two” listed as the number guide, and so on.

As seen in FIGS. 1-2, in the ideal embodiment, the plurality of guide dots 302 is positioned on each of the plurality of reference letters 306 to indicate where to begin a stroke with a writing implement. The plurality of arrow guides 304 is positioned adjacent to each of the plurality of reference letters 306 to indicate what direction a stroke with a writing implement should take. The plurality of number guides 308 is positioned adjacent to each of the plurality of arrow guides 304 to indicate the order in which strokes should be made.

Moving now into the method of use, the following describes methods of use for the handwriting scoring tool 100. A number of scoring methods can be implemented using the handwriting scoring tool 100. This includes scoring letter and number size, scoring letter and number placement on the baseline, scoring word spacing, scoring letter spacing, and judging letter and number formation.

First, a user may score letter and number size using the handwriting scoring tool 100. First, the user overlays the transparency sheet 102 on the paper to be scored. When scoring letter size, the user lines up the box baseline 206 with the bottom of the letter or character to be scored. In the case of capital letters, tall lowercase letters, descending lowercase letters, and numbers, these characters should fit within the height of the entire solid black outline of a box of the at least one box. Some letters may have parts that are contained within the bottom half of the box, while another part is in the top half of the box. For example, a lowercase “g” would have the bottom part of the “g” lined up with the baseline when scoring letter size. The round part of the “g” should be within the top part of the box, and the descending portion should be in the bottom half of the box. Small lowercase letters should fit within the bottom half of the box. Once the user has made a determination of the letter sizing, the user may determine a scoring for the character being scored.

Next, a user may further score letter and number placement in relation to the baseline. First, the user overlays the transparency sheet 102 on the paper to be scored. The user then aligns the paper being scored with the box baseline 206 of a selected box on the transparency sheet 102. Any character that falls outside of the area indicated by the baseline aligner 204 may be scored as incorrect. For example, when scoring the lowercase letter “g” as above, the round part of the “g” should sit on the baseline and fall within the shaded area indicated by the baseline aligner 204.

Next, a user may further score the spacing between words. Generally, there should be enough space to fit approximately one character between each word. To grade this, the tool is placed on top of the paper to be scored with a selected box on the transparency sheet 102 placed immediately to the right of a word being scored, so that the left side of the selected box lines up with the right side of the selected word. There should be space to fit between one or two of the selected box between words. If the space is more or less than that amount, the spacing can be marked as incorrect.

Next, a user may further score the spacing between letters. Generally, there should not be enough space to insert an additional letter within the word. The handwriting scoring tool 100 is placed on the paper with the selected box next to the letter within the word. The letters should be close enough that the box does not fit within the space between the letters, but the letters should not be so close that they touch or overlap. If there is space to fit the entirety of the selected box between the letters of the word, the word may be scored as having incorrect spacing.

Finally, using the embodiment having the handwriting guide 300, a user may judge letter and number formation. The user need not place the handwriting scoring tool 100 directly on the writing sample to score this. First, the user watches the student form each letter, and compares the student's formation to the reference on the handwriting scoring tool 100. The user compares both the stroke order and stroke direction to determine whether the letter or number was correctly formed. Characters written should start at the dots from the plurality of guide dots 302, and then the strokes are formed in the direction indicated by the plurality of arrow guides 304 and the sequence indicated by the plurality of number guides 308. If the stroke order or direction do not match the order and direction show by the handwriting guide 300, the writing can be scored as incorrect.

Although the invention has been explained in relation to its preferred embodiment, it is to be understood that many other possible modifications and variations can be made without departing from the spirit and scope of the invention.

I claim:

1. A handwriting scoring tool comprising:
a transparency sheet;
the transparency sheet further comprising a transparent base and permanent ink;
wherein the transparent base is either clear or frosted;
wherein the permanent ink forms at least one printed box; and
wherein the at least one printed box comprises a box baseline and a dashed midline.

2. The handwriting scoring tool of claim 1, further comprising:
the transparency sheet further comprising a waterproof material.

3. The handwriting scoring tool of claim 1, further comprising:
the at least one printed box further comprising a baseline aligner.

4. The handwriting scoring tool of claim 3, further comprising:
wherein the baseline aligner comprises a partially opaque shaded shape.

5. The handwriting scoring tool of claim 1, further comprising:
the at least one printed box comprising a first box, a second box, a third box, a fourth box, and a fifth box.

6. The handwriting scoring tool of claim 5, further comprising:
wherein the first box is smaller than the second box;
wherein the second box is smaller than the third box;
wherein the third box is smaller than the fourth box; and
wherein the fourth box is smaller than the fifth box.

7. The handwriting scoring tool of claim 5, further comprising:
wherein only the fifth box does not comprise a baseline aligner.

8. The handwriting scoring tool of claim 7, further comprising:
wherein the baseline aligner of the fourth box is larger in comparison to the baseline aligner of the first box, second box, and third box.

9. The handwriting scoring tool of claim 1, further comprising:
the permanent ink forming a handwriting guide.

10. The handwriting scoring tool of claim 9, further comprising:
the handwriting scoring tool further comprising a plurality of guide dots, a plurality of arrow guides, a plurality of reference letters, and a plurality of number guides.

11. The handwriting scoring tool of claim 10, further comprising:
the plurality of guide dots being positioned on each of the plurality of reference letters to indicate where to begin a stroke with a writing implement;
the plurality of arrow guides being positioned adjacent to each of the plurality of reference letters to indicate what direction a stroke with a writing implement should take; and
a number guide of the plurality of number guides being positioned adjacent to each of the plurality of arrow guides to indicate the order in which the strokes should be made.

12. A handwriting scoring tool comprising:
a transparency sheet;
the transparency sheet further comprising a transparent base and permanent ink;
the transparency sheet further comprising a waterproof material;
wherein the transparent base is either clear or frosted;
wherein the permanent ink forms at least one printed box;
wherein the at least one printed box comprises a box baseline and a dashed midline;
the at least one printed box further comprising a baseline aligner;
wherein the baseline aligner comprises a partially opaque shaded shape;
the permanent ink forming a handwriting guide; and
the handwriting scoring tool further comprising a plurality of guide dots, a plurality of arrow guides, a plurality of reference letters, and a plurality of number guides.

13. The handwriting scoring tool of claim 12, further comprising:
the at least one printed box comprising a first box, a second box, a third box, a fourth box, and a fifth box;
wherein the first box is smaller than the second box;
wherein the second box is smaller than the third box;
wherein the third box is smaller than the fourth box; and
wherein the fourth box is smaller than the fifth box.

14. The handwriting scoring tool of claim 13, further comprising:
wherein only the fifth box does not comprise a baseline aligner.

15. The handwriting scoring tool of claim 14, further comprising:
wherein the baseline aligner of the fourth box is larger in comparison to the baseline aligner of the first box, second box, and third box.

16. The handwriting scoring tool of claim 12, further comprising:
the plurality of guide dots being positioned on each of the plurality of reference letters to indicate where to begin a stroke with a writing implement;
the plurality of arrow guides being positioned adjacent to each of the plurality of reference letters to indicate what direction a stroke with a writing implement should take; and
a number guide of the plurality of number guides being positioned adjacent to each of the plurality of arrow guides to indicate the order in which the strokes should be made.

17. A handwriting scoring tool comprising:
a transparency sheet;
the transparency sheet further comprising a transparent base and permanent ink;
the transparency sheet further comprising a waterproof material;
wherein the transparent base is either clear or frosted;
wherein the permanent ink forms at least one printed box;
wherein the at least one printed box comprises a box baseline and a dashed midline;
the at least one printed box further comprising a baseline aligner;
wherein the baseline aligner comprises a partially opaque shaded shape;
the permanent ink forming a handwriting guide;
the handwriting scoring tool further comprising a plurality of guide dots, a plurality of arrow guides, a plurality of reference letters, and a plurality of number guides;
the plurality of guide dots being positioned on each of the plurality of reference letters to indicate where to begin a stroke with a writing implement;
the plurality of arrow guides being positioned adjacent to each of the plurality of reference letters to indicate what direction a stroke with a writing implement should take; and
a number guide of the plurality of number guides being positioned adjacent to each of the plurality of arrow guides to indicate the order in which the strokes should be made.

18. The handwriting scoring tool of claim 17, further comprising:
the at least one printed box comprising a first box, a second box, a third box, a fourth box, and a fifth box;
wherein the first box is smaller than the second box;
wherein the second box is smaller than the third box;
wherein the third box is smaller than the fourth box; and
wherein the fourth box is smaller than the fifth box.

19. The handwriting scoring tool of claim 18, further comprising:
wherein only the fifth box does not comprise a baseline aligner.

20. The handwriting scoring tool of claim 19, further comprising:
wherein the baseline aligner of the fourth box is larger in comparison to the baseline aligner of the first box, second box, and third box.
